(19) United States
(12) Patent Application Publication
(10) Pub. No.: US 2018/0300620 A1
(43) Pub. Date: Oct. 18, 2018

(54) Foliage Detection Training Systems And Methods

(71) Applicant: Ford Global Technologies, LLC, Dearborn, MI (US)

(72) Inventors: Marcos Paul Gerardo Castro, Mountain View, CA (US); Jinesh J. Jain, Palo Alto, CA (US); Sneha Kadetotad, Cupertino, CA (US); Dongran Liu, San Jose, CA (US)

(21) Appl. No.: 15/486,099

(22) Filed: Apr. 12, 2017

(51) Int. Cl. G06N 3/08; G01S 17/93; G01S 13/94; G01S 15/93; G01S 13/93; G05D 1/00; H04N 7/18; G06T 7/11; G06K 9/62

(52) U.S. Cl. CPC G06N 3/08; G01S 17/936; G01S 13/94; G01S 15/931; G06K 9/6269; G05D 1/0088; H04N 7/183; G06T 7/11; G01S 13/93

(57) ABSTRACT

Example foliage detection training systems and methods are described. In one implementation, a method receives data associated with a plurality of vehicle-mounted sensors and defines multiple regions of interest (ROIs) based on the received data. The method applies a label to each ROI, where the label classifies a type of foliage associated with the ROI. A foliage detection training system trains a machine learning algorithm based on the ROIs and associated labels.

### TECHNICAL FIELD

The present disclosure relates to systems and methods that train and test foliage detection systems, such as foliage detection systems used by a vehicle.

### BACKGROUND

Automobiles and other vehicles provide a significant portion of transportation for commercial, government, and private entities. Autonomous vehicles and driving assistance systems are currently being developed and deployed to provide safety features, reduce an amount of user input required, or even eliminate user involvement entirely. For example, some driving assistance systems, such as crash avoidance systems, may monitor driving, positions, and a velocity of the vehicle and other objects while a human is driving. When the system detects that a crash or impact is imminent the crash avoidance system may intervene and apply a brake, steer the vehicle, or perform other avoidance or safety maneuvers. As another example, autonomous vehicles may drive, navigate, and/or park a vehicle with little or no user input. Since obstacle avoidance is a key part of automated or assisted driving, it is important to correctly detect and classify detected objects or surfaces. In some situations, if a detected obstacle is foliage, it is important to determine the type of foliage and predict the danger presented to the vehicle by the particular foliage. For example, a large tree trunk is more dangerous to a vehicle than a small plant or shrub.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a block diagram illustrating an embodiment of a vehicle control system.

FIG. 2 is a block diagram illustrating an embodiment of a foliage detection training system.

FIG. 3 illustrates an embodiment of a vehicle with multiple sensors mounted to the vehicle.

FIG. 4 illustrates an example view of foliage near a vehicle.

FIG. 5 illustrates an embodiment of a method for training and testing a foliage detection system.

### DETAILED DESCRIPTION

In the following disclosure, reference is made to the accompanying drawings, which form a part hereof, and in which is shown by way of illustration specific implementations in which the disclosure may be practiced. It is understood that other implementations may be utilized and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Implementations of the systems, devices, and methods disclosed herein may comprise or utilize a special purpose or general-purpose computer including computer hardware, such as, for example, one or more processors and system memory, as discussed herein. Implementations within the scope of the present disclosure may also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, implementations of the disclosure can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

An implementation of the devices, systems, and methods disclosed herein may communicate over a computer network. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links, which can be used to carry desired program code means in the form of computer-executable instructions or data structures and which can be accessed by a general purpose or special purpose computer. Combinations of the above should also be included within the scope of computer-readable media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter is described in language specific to structural features and/or methodological acts, it is to be understood that the subject matter defined in the appended claims is not necessarily limited to the described features or acts described herein. Rather, the described features and acts are disclosed as example forms of implementing the claims.

Those skilled in the art will appreciate that the disclosure may be practiced in network computing environments with many types of computer system configurations, including, an in-dash vehicle computer, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the description and claims to refer to particular system components. As one skilled in the art will appreciate, components may be referred to by different names. This document does not intend to distinguish between components that differ in name, but not function.

It should be noted that the sensor embodiments discussed herein may comprise computer hardware, software, firmware, or any combination thereof to perform at least a portion of their functions. For example, a sensor may include computer code configured to be executed in one or more processors, and may include hardware logic/electrical circuitry controlled by the computer code. These example devices are provided herein purposes of illustration, and are not intended to be limiting. Embodiments of the present disclosure may be implemented in further types of devices, as would be known to persons skilled in the relevant art(s).

At least some embodiments of the disclosure are directed to computer program products comprising such logic (e.g., in the form of software) stored on any computer useable medium. Such software, when executed in one or more data processing devices, causes a device to operate as described herein.

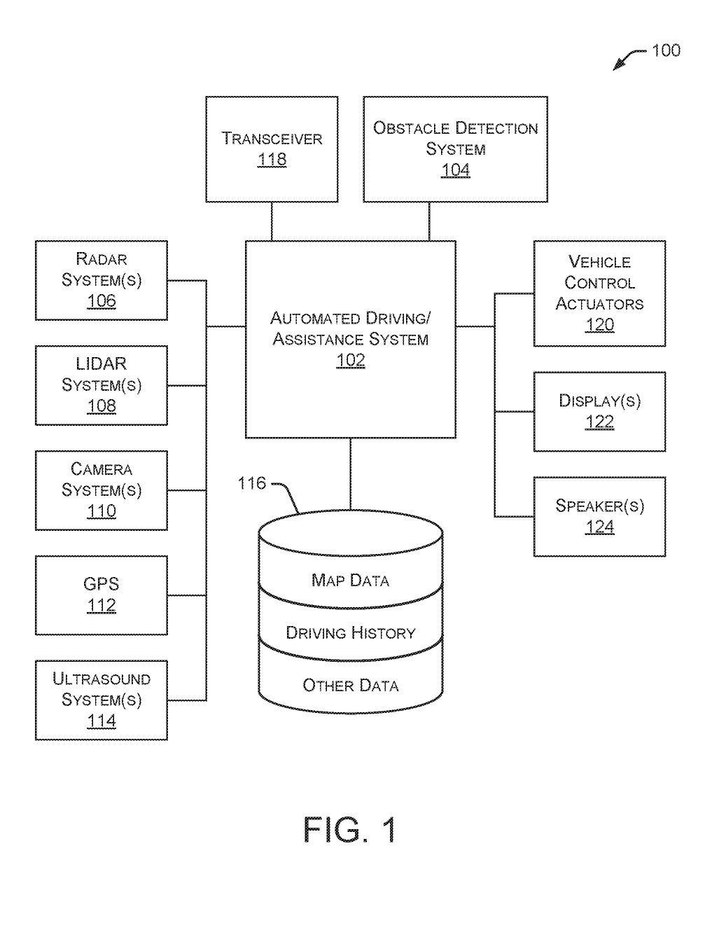

FIG. 1 is a block diagram illustrating an embodiment of a vehicle control system 100 within a vehicle that includes an obstacle detection system 104. An automated driving/assistance system 102 may be used to automate or control operation of a vehicle or to provide assistance to a human driver. For example, the automated driving/assistance system 102 may control one or more of braking, steering, seat belt tension, acceleration, lights, alerts, driver notifications, radio, vehicle locks, or any other auxiliary systems of the vehicle. In another example, the automated driving/assistance system 102 may not be able to provide any control of the driving (e.g., steering, acceleration, or braking), but may provide notifications and alerts to assist a human driver in driving safely.

Vehicle control system 100 includes obstacle detection system 104 that interacts with various components in the vehicle control system to detect and respond to potential (or likely) obstacles located near the vehicle (e.g., in the path of the vehicle). In one embodiment, obstacle detection system 104 detects foliage near the vehicle, such as in front of the vehicle or behind the vehicle. As used herein, “foliage” refers to leaves, grass, plants, flowers, bushes, shrubs, tree branches, and the like. Although obstacle detection system 104 is shown as a separate component in FIG. 1, in alternate embodiments, obstacle detection system 104 may be incorporated into automated driving/assistance system 102 or any other vehicle component.

The vehicle control system 100 also includes one or more sensor systems/devices for detecting a presence of nearby objects (or obstacles) or determining a location of a parent vehicle (e.g., a vehicle that includes the vehicle control system 100). For example, the vehicle control system 100 may include one or more radar systems 106, one or more LIDAR systems 108, one or more camera systems 110, a global positioning system (GPS) 112, and/or ultrasound systems 114. The one or more camera systems 110 may include a rear-facing camera mounted to the vehicle (e.g., a rear portion of the vehicle), a front-facing camera, and a side-facing camera. Camera systems 110 may also include one or more interior cameras that capture images of passengers and other objects inside the vehicle. The vehicle control system 100 may include a data store 116 for storing relevant or useful data for navigation and safety, such as map data, driving history, or other data. The vehicle control system 100 may also include a transceiver 118 for wireless communication with a mobile or wireless network, other vehicles, infrastructure, or any other communication system.

The vehicle control system 100 may include vehicle control actuators 120 to control various aspects of the driving of the vehicle such as electric motors, switches or other actuators, to control braking, acceleration, steering, seat belt tension, door locks, or the like. The vehicle control system 100 may also include one or more displays 122, speakers 124, or other devices so that notifications to a human driver or passenger may be provided. A display 122 may include a heads-up display, dashboard display or indicator, a display screen, or any other visual indicator, which may be seen by a driver or passenger of a vehicle. The speakers 124 may include one or more speakers of a sound system of a vehicle or may include a speaker dedicated to driver or passenger notification.

It will be appreciated that the embodiment of FIG. 1 is given by way of example only. Other embodiments may include fewer or additional components without departing from the scope of the disclosure. Additionally, illustrated components may be combined or included within other components without limitation.

In one embodiment, the automated driving/assistance system 102 is configured to control driving or navigation of a parent vehicle. For example, the automated driving/assistance system 102 may control the vehicle control actuators 120 to drive a path on a road, parking lot, driveway or other location. For example, the automated driving/assistance system 102 may determine a path based on information or perception data provided by any of the components 106-118. A path may also be determined based on a route that maneuvers the vehicle to avoid or mitigate a potential collision with another vehicle or object. The sensor systems/devices 106-110 and 114 may be used to obtain real-time sensor data so that the automated driving/assistance system 102 can assist a driver or drive a vehicle in real-time.

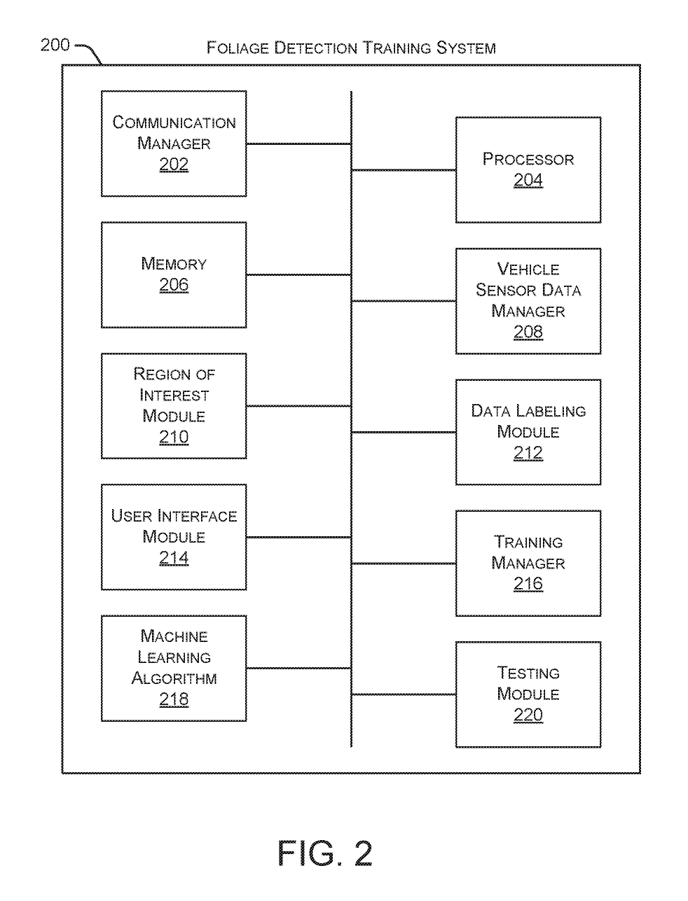

FIG. 2 is a block diagram illustrating an embodiment of a foliage detection training system 200. As shown in FIG. 2, foliage detection training system 200 includes a communication manager 202, a processor 204, and a memory 206. Communication manager 202 allows foliage detection training system 200 to communicate with other systems, such as automated driving/assistance system 102 and data sources providing virtual training data. Processor 204 executes various instructions to implement the functionality provided by foliage detection training system 200, as discussed herein. Memory 206 stores these instructions as well as other data used by processor 204 and other modules and components contained in foliage detection training system 200.

Additionally, foliage detection training system 200 includes a vehicle sensor data manager 208 that receives and manages data associated with multiple vehicle sensors. As discussed herein, this received data may include actual sensor data from one or more actual vehicles. Additionally, the received data may include virtual data created for the purpose of training and testing foliage detection systems. In some embodiments, the virtual data includes computer generated image data, computer generated radar data, computer generated Lidar data or computer generated ultrasound data. Vehicle sensor data manager 208 may also identify and manage object level data or raw level data within the received data. A region of interest module 210 identifies one or more regions of interest (ROIs) from the received data. A data labeling module 212 assists with labeling each ROI and storing data related to the label associated with each ROI. As discussed herein, each ROI may be labeled to classify the type of foliage (if any) present in the ROI. For example, data may be classified as non-vegetation, dangerous vegetation, non-dangerous vegetation or unknown vegetation.

Foliage detection training system 200 also includes a user interface module 214 that allows one or more users to interact with the foliage detection training system 200. For example, one or more users may assist with labeling each ROI. A training manager 216 assists with the training of a machine learning algorithm 218, such as a deep neural network, a convolutional neural network, a deep belief network, a recurring network, and the like. A testing module 220 performs various tests on machine learning algorithm 218 to determine the accuracy and consistency of machine learning algorithm 218 in detecting foliage in the vehicle sensor data.

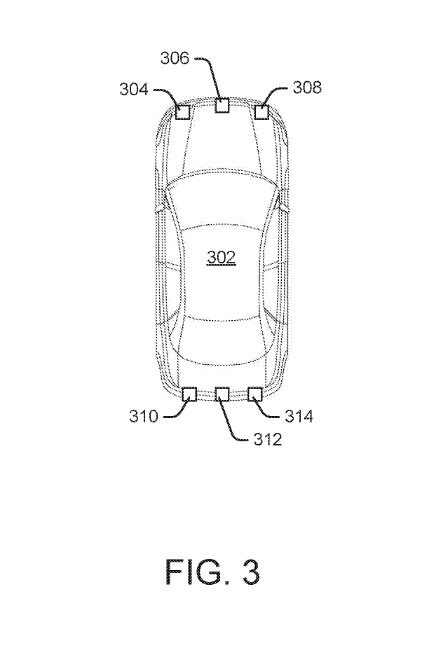

FIG. 3 illustrates an embodiment of a vehicle 302 with multiple sensors mounted to the vehicle. Vehicle 302 includes any number of sensors, such as the various types of sensors discussed herein. In the particular example of FIG. 3, vehicle 302 includes Lidar sensors 304 and 310, a forward-facing camera 306, a rear-facing camera 312, and radar sensors 308 and 314. Vehicle 302 may have any number of additional sensors (not shown) mounted in multiple vehicle locations. For example, particular embodiments of vehicle 302 may also include other types of sensors such as ultrasound sensors. In the example of FIG. 3, sensors 304-314 are mounted near the front and rear of vehicle 302. In alternate embodiments, any number of sensors may be mounted in different locations of the vehicle, such as on the sides of the vehicle, the roof of the vehicle, or any other mounting location.

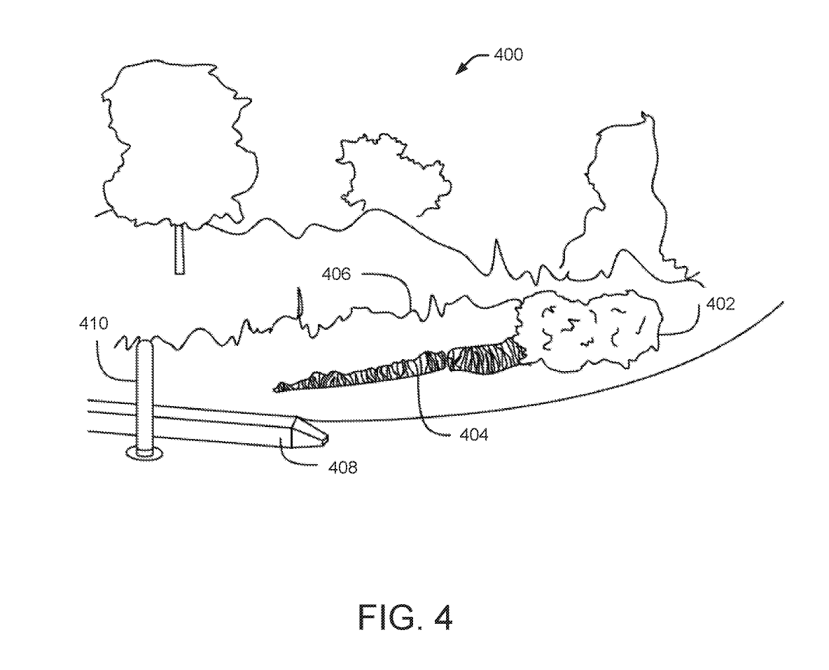

FIG. 4 illustrates an example view of region 400 near a vehicle which contains foliage that may be detected using one or more vehicle-mounted sensors of the type discussed herein. The region 400 includes both solid objects and foliage, which may be detected by a sensor of a vehicle. Specifically, the foliage includes bushes 402, grass 404, and other shrubbery 406. In some circumstances, it may be acceptable for a vehicle to contact or drive over the foliage because damage to the vehicle or a person may be less likely. The solid objects shown in region 400 include a curb 408 and a pole 410, which may result in damage or harm to a vehicle, passenger, or the objects themselves. As discussed herein, sensor data may be captured or generated (e.g., virtual data) that simulates at least a portion of the solid objects and/or foliage shown in region 400. This captured or generated sensor data is used to train and test a foliage detection system as discussed in greater detail below. In some embodiments, the generated sensor data includes random types of foliage items in random locations near the vehicle.

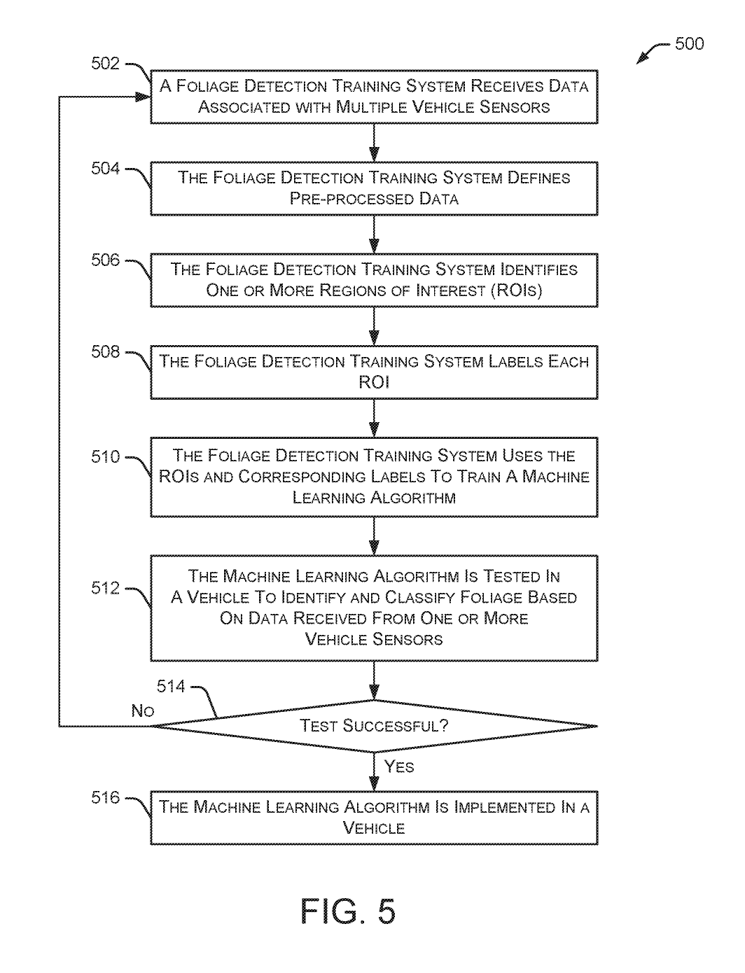

FIG. 5 illustrates an embodiment of a method 500 for training and testing a foliage detection system. Initially, a foliage detection training system (e.g., foliage detection training system 200) receives 502 data associated with multiple vehicle sensors, such as a LIDAR sensor, a radar sensor, an ultrasound sensor or a camera. The received data may be actual data captured by sensors mounted to actual vehicles. Alternatively, the received data may be virtual data that has been generated to simulate sensor output data for use in training and testing a foliage detection system. The received data may be referred to as “training data” used, for example, to train and test a foliage detection system. In some embodiments, method 500 preprocesses the received data to eliminate noise, register data from different sensors, perform geo-referencing, and the like.

The foliage detection training system defines 504 pre-processed data, such as data that has been de-noised, geo-referenced, and is free of outliers. In some embodiments, the pre-processing of data includes one or more of: receiving data from each sensing modality (e.g., each actual or simulated vehicle sensor), analyzing the data to eliminate (or reduce) noise, performing registration on the data, geo-referencing the data, eliminating outliers, and the like. This data represents, for example, at least a portion of the example view shown in FIG. 4. Method 500 continues as the foliage detection training system identifies 506 one or more regions of interest (ROIs) from the pre-processed data. The ROI may include one or more foliage items or other objects that represent potential obstacles to the vehicle. In some embodiments, known clustering and/or data segmentation techniques are used to identify objects and associated ROIs. In some embodiments, the ROI can be obtained using a clustering method such as hierarchical, density-based, subspace, and the like. Additionally, the ROI can be obtained using a segmentation method such as methods based on histograms, region growing, Markov Random fields, and the like. The use of a ROI helps reduce computational cost of analyzing the data because the computation is limited to the specific ROI that is likely to contain a foliage item or other object.

The foliage detection training system then labels 508 each ROI. The labeling of each ROI includes classifying each foliage object as: dangerous vegetation, non-dangerous vegetation, unknown vegetation or non-vegetation. The dangerous vegetation classifier corresponds to situations where the foliage (or vegetation) can cause imminent harm to a vehicle if a collision occurs. An example of dangerous vegetation is a large tree trunk. The non-dangerous vegetation classifier corresponds to situations where the vegetation is not likely to cause any harm to the integrity of the vehicle even if the vehicle collides with the vegetation.

Examples of non-dangerous vegetation include grass and small bushes. The unknown vegetation classifier corresponds to situations where it is difficult to evaluate the level of harm to the vehicle. Examples of unknown vegetation include dense tree branches or tall and dense bushes. The non-vegetation classifier corresponds to all items or objects that are not vegetation or foliage, such as pedestrians, poles, walls, curbs, and the like. In some embodiments, the labeling of each ROI is performed by a human user. In other embodiments, the labeling of each ROI is performed automatically by a computing system or performed by a computing system with human user verification.

Method 500 continues as foliage detection training system trains 510 a machine learning algorithm using the data from each ROI and the corresponding label. In some embodiments, the machine learning algorithm is a deep neural network, convolutional neural network, deep belief network, recurrent network, auto-encoder or any other machine learning algorithm. The resulting machine learning algorithm is useful in classifying foliage items, as discussed above.

The machine learning algorithm is tested 512 in an actual vehicle to identify and classify foliage based on data received from one or more vehicle sensors. In some embodiments, the testing of the machine learning algorithm includes user input to confirm whether the machine learning algorithm accurately identified all foliage items and accurately classified the foliage items.

If the test is not successful 514, the method returns to 502 and continues receiving additional data, which is used to further train the machine learning algorithm. If the test is successful 514, the machine learning algorithm is implemented 516 in one or more production vehicles. For example, the machine learning algorithm may be incorporated into a foliage detection system or an obstacle detection system in a vehicle. Based on the identified foliage items and their associated classifications, an automated driving/assistance system may determine the potential danger of running into (or driving over) foliage items during operation of the vehicle.

While various embodiments of the present disclosure are described herein, it should be understood that they are presented by way of example only, and not limitation. It will be apparent to persons skilled in the relevant art that various changes in form and detail can be made therein without departing from the spirit and scope of the disclosure. Thus, the breadth and scope of the present disclosure should not be limited by any of the described exemplary embodiments, but should be defined only in accordance with the following claims and their equivalents. The description herein is presented for the purposes of illustration and description. It is not intended to be exhaustive or to limit the disclosure to the precise form disclosed. Many modifications and variations are possible in light of the disclosed teaching. Further, it should be noted that any or all of the alternate implementations discussed herein may be used in any combination desired to form additional hybrid implementations of the disclosure.

1. A method comprising:
receiving data associated with a plurality of vehicle-mounted sensors;
defining, by a foliage detection training system, multiple regions of interest (ROIs) based on the received data;
applying a label to each ROI, wherein the label classifies a type of foliage associated with the ROI; and
training, by the foliage detection training system, a machine learning algorithm based on the ROIs and associated labels.

2. The method of claim 1, wherein the plurality of vehicle-mounted sensors include at least one of a LIDAR sensor, a radar sensor, an ultrasound sensor, and a camera.

3. The method of claim 1, further comprising pre-processing the received data, wherein the pre-processing of the received data includes at least one of eliminating noise from the data, performing registration of the data, geo-referencing the data, and eliminating outliers.

4. The method of claim 1, further comprising testing the machine learning algorithm in a vehicle using actual data received from at least one sensor mounted to the vehicle.

5. The method of claim 1, further comprising implementing the machine learning algorithm in a vehicle by an automated driving system, wherein the machine learning algorithm classifies foliage proximate the vehicle based on data received from at least one sensor mounted to the vehicle.

6. The method of claim 1, wherein the machine learning algorithm is a deep neural network.

7. The method of claim 1, wherein the label applied to each ROI includes one of non-vegetation, dangerous vegetation, non-dangerous vegetation, and unknown vegetation.

8. The method of claim 1, wherein the received data associated with the plurality of vehicle-mounted sensors includes at least one of computer generated image data, computer generated radar data, computer generated Lidar data, and computer generated ultrasound data.

9. The method of claim 1, wherein the received data associated with the plurality of vehicle-mounted sensors includes random generation of different types of foliage in different locations proximate the vehicle.

10. The method of claim 1, wherein the received data associated with the plurality of vehicle-mounted sensors includes virtual data.

11. The method of claim 1, further comprising incorporating the machine learning algorithm into a foliage detection system in a vehicle.

12. A method comprising:
receiving data associated with a plurality of vehicle-mounted sensors;
pre-processing the received data, wherein the pre-processing of the received data includes at least one of eliminating noise from the data, performing registration of the data, geo-referencing the data, and eliminating outliers;
defining, by a foliage detection training system, multiple regions of interest (ROIs) based on the pre-processed data;
applying a label to each ROI, wherein the label classifies a type of foliage associated with the ROI; and
training, by the foliage detection training system, a machine learning algorithm based on the ROIs and associated labels.

13. The method of claim 12, wherein the plurality of vehicle-mounted sensors include at least one of a LIDAR sensor, a radar sensor, an ultrasound sensor, and a camera.

14. The method of claim 12, further comprising testing the machine learning algorithm in a vehicle using actual data received from at least one sensor mounted to the vehicle.

15. The method of claim 12, wherein the label applied to each ROI includes one of non-vegetation, dangerous vegetation, non-dangerous vegetation, and unknown vegetation.

16. The method of claim 12, wherein the machine learning algorithm is a deep neural network.

17. An apparatus comprising:
a communication manager configured to receive data associated with a plurality of vehicle-mounted sensors;
a region of interest module configured to define multiple regions of interest (ROIs) based on the received data;
a data labeling module configured to label to each ROI, wherein the label classifies a type of foliage associated with the ROI; and
a training manager configured to train a machine learning algorithm based on the ROIs and associated labels.

18. The apparatus of claim 17, further comprising a testing module configured to test the machine learning algorithm in a vehicle using actual data received from at least one sensor mounted to the vehicle.

19. The apparatus of claim 17, wherein the machine learning algorithm is a deep neural network.

20. The apparatus of claim 17, wherein the label applied to each ROI includes one of non-vegetation, dangerous vegetation, non-dangerous vegetation, and unknown vegetation.
